(19) United States
(12) Patent Application Publication
(10) Pub. No.: US 2011/0094265 A1
(43) Pub. Date: Apr. 28, 2011

(54) JEWELRY PENDANT TO HOLD AN ASPIRIN

(76) Inventors: Uwe Karl Dost, Lahaina, HI (US); Russel Dampler, Littleton, CO (US); Volker Dost, Las Vegas, NV (US)

(21) Appl. No.: 12/607,876

(22) Filed: Oct. 28, 2009

(51) Int. Cl. A44C 25/00; F16J 15/02

(52) U.S. Cl. 63/1.14; 277/644

(57) ABSTRACT

Herein is described a device and a method for providing an emergency supply of a medicine including providing a piece of jewelry able to hold a medicine, the piece of jewelry comprising a pendent having an attachment ring and a sealable container, the sealable container having a chamber with a cover attached to the chamber by a hinge; and a clasp whereby the cover can be sealed closed, placing a supply of medicine within the sealable container and sealing the cover closed, carrying the piece of jewelry with a supply of medicine until an emergency occurs, and unsealing the sealable container and removing the medicine, thereby providing an emergency supply of medicine.

### BACKGROUND OF THE INVENTION

The present invention generally relates to a pendant capable of holding a tablet such as an aspirin. It is useful to have an aspirin handy at all times in case someone has a heart attack or stroke. Not everybody can carry a bottle of aspirin with them, especially on the beach or when running or walking, riding a bike or even while driving a car.

As can be seen, there is a need for a device such as a jewelry pendant a person will always have with them, that can be worn as a necklace, a pendent, on a bracelet, or on a key chain or the like. Not only could it save your own life, you may help someone else.

### SUMMARY OF THE INVENTION

In one aspect of the present invention, a piece of jewelry able to hold a substance includes a pendent having an attachment ring and a sealable container, the sealable container comprising a chamber with a cover attached to the chamber by a hinge, and a clasp whereby the cover can be sealed closed such that the substance can be removably held within the chamber.

In another aspect of the present invention, a method of providing an emergency supply of a medicine includes providing a piece of jewelry able to hold a medicine, the piece of jewelry comprising a pendent having an attachment ring and a sealable container, the sealable container having a chamber with a cover attached to the chamber by a hinge; and a clasp whereby the cover can be sealed closed, placing a supply of medicine within the sealable container and sealing the cover closed, carrying the piece of jewelry with a supply of medicine until an emergency occurs, and unsealing the sealable container and removing the medicine, thereby providing an emergency supply of medicine.

These and other features, aspects and advantages of the present invention will become better understood with reference to the following drawings, description and claims.

### BRIEF DESCRIPTION OF THE DRAWINGS

FIG. 1 shows a perspective view of an exemplary embodiment of the invention.

FIG. 2 shows a front view of an exemplary embodiment of the invention.

FIG. 3 shows a side view of an exemplary embodiment of the invention.

FIG. 4 shows a section view of an exemplary embodiment of the invention taken along line 4-4 in FIG. 2.

FIG. 5 shows a detailed section view of the hinge (24) and O-ring seal (20) of an exemplary embodiment of the invention.

FIG. 6 shows a detailed section view of the clasp (22) and O-ring seal (20) of an exemplary embodiment of the invention.

FIG. 7 shows a perspective view of an exemplary alternative embodiment of the invention.

FIG. 8 shows a front view of the exemplary alternative embodiment of the invention of FIG. 7.

FIG. 9 shows a side view of the exemplary alternative embodiment of the invention FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a pendant with a chamber designed to hold one or two tablets or capsules. The chamber is preferably waterproof such that the device can be worn in the ocean or a swimming pool.

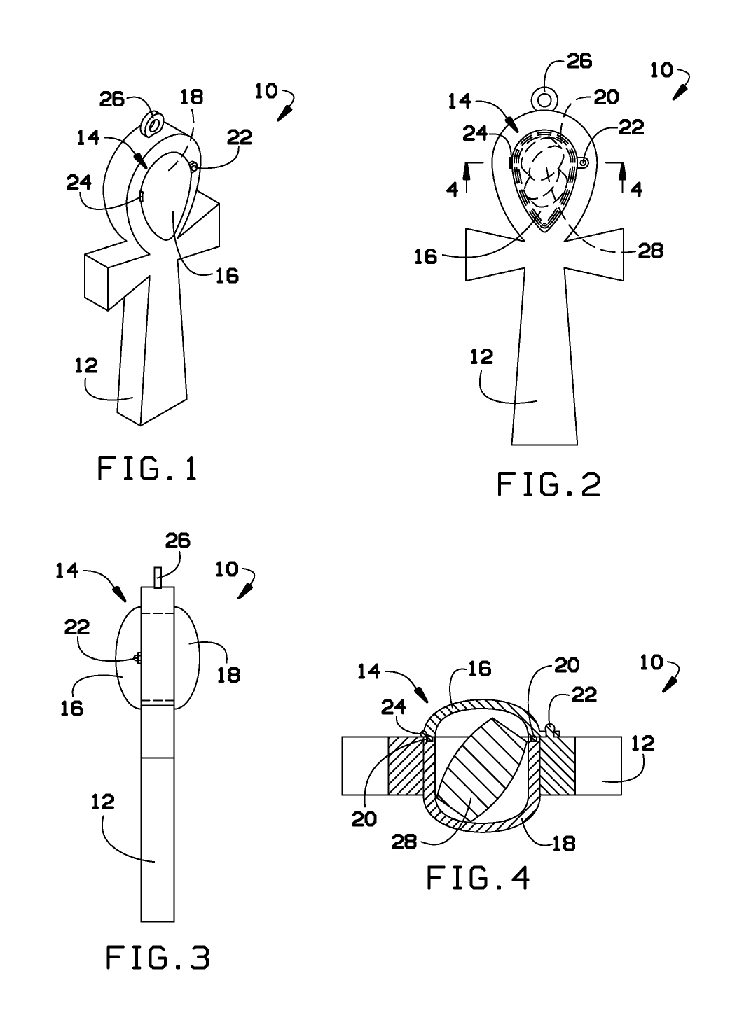

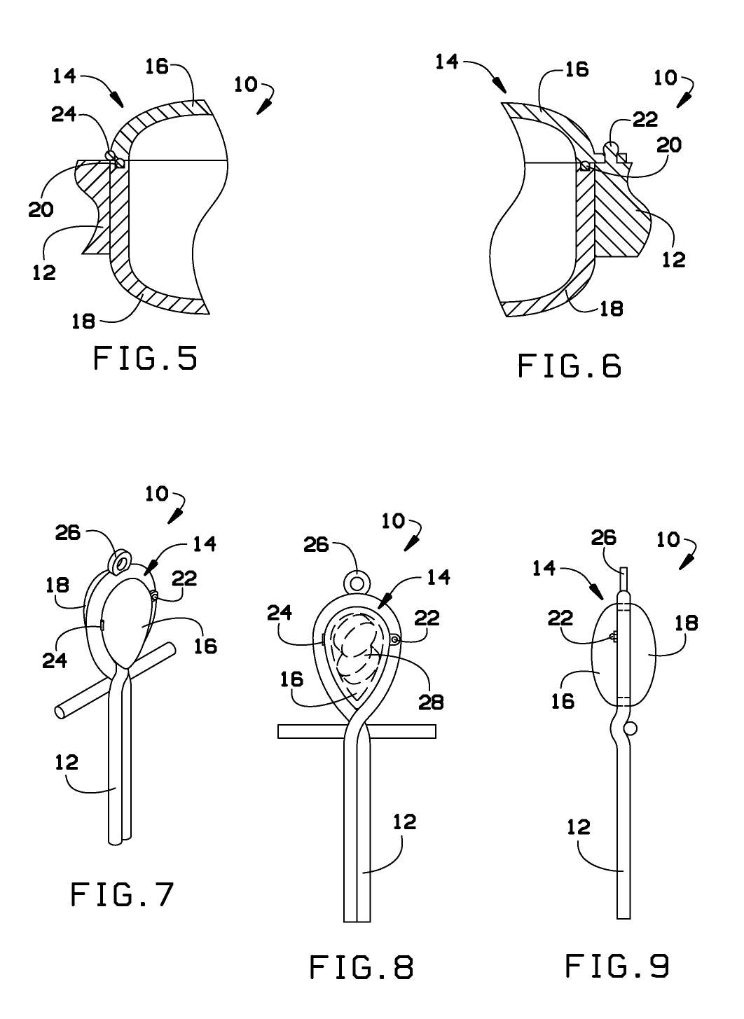

In one exemplary embodiment shown in FIG. 1-6, the device (10) has a shape similar to an Egyptian Ankh. The exemplary embodiment comprises a pendent (12) with a sealable container (14) and a pendant attachment ring (26) at the top (FIG. 1-3). The sealable container can have a chamber (18) typically capable of holding one or two tablets or capsules (28) (FIG. 4), and a cover (16) with a hinge (24) and a clasp (22). The cover (16) can be opened to insert or remove the tablet (28). The cover (16) can make a watertight seal with the chamber (18) by use of a recessed O-ring (20) (FIGS. 5 and 6). The recessed O-ring (20) can be set into the rim of the chamber (18).

The pendent (12) can be made from stainless steel, gold, silver, ceramic or other appropriate material. The material is preferably decorative, water-resistant and resists corrosion.

The length of the device (10) in the longest dimension is typically two inches or less, but large enough to support a chamber (18) capable of containing up to two typical sized aspirin tablets.

An alternative exemplary embodiment of the device (10) is shown in FIG. 7-9 where the pendent (12) has an alternative form. Other forms are contemplated and within the scope of the instant invention.

In order to use the device, one can wear the device around one's neck on a chain, attached to one's bracelet, or on one's keychain, and when an aspirin is needed it will always be available.

In an alternative embodiment, instead of aspirins one can put other medications or supplements in the device. In addition, the device can serve a decorative function and look like a nice piece of jewelry.

It should be understood, of course, that the foregoing relates to exemplary embodiments of the invention and that modifications may be made without departing from the spirit and scope of the invention as set forth in the following claims.

We claim:

1. A piece of jewelry able to hold a substance comprising:
a pendent having an attachment ring and a sealable container, the sealable container comprising a chamber with a cover attached to the chamber by a hinge; and
a clasp whereby the cover can be sealed closed;
wherein the substance can be removably held within the chamber with a cover.

2. The piece of jewelry of claim 1 further comprising an O-ring adapted to form a watertight seal between the chamber and the cover.

3. The piece of jewelry of claim 1 where the jewelry has the shape of an Egyptian Ankh.

4. The piece of jewelry of claim 1 where the jewelry is made of stainless steel, gold, silver, or ceramic.

5. The piece of jewelry of claim 1 where the substance is a medicine.

6. The piece of jewelry of claim 5 where the medicine is aspirin.

7. A method of providing an emergency supply of a medicine comprising:
providing a piece of jewelry able to hold a medicine, the piece of jewelry comprising: a pendent having an attachment ring and a sealable container, the sealable container having a chamber with a cover attached to the chamber by a hinge; and a clasp whereby the cover can be sealed closed;
placing a supply of medicine within the sealable container and sealing the cover closed;
carrying the piece of jewelry with a supply of medicine until an emergency occurs;
unsealing the sealable container and removing the medicine, thereby providing an emergency supply of medicine.

8. The method of claim 7 wherein the piece of jewelry further comprises an O-ring adapted to form a watertight seal between the chamber and the cover.

9. The method of claim 7 wherein the medicine is aspirin.
